(19) United States
(12) Patent Application Publication
(10) Pub. No.: US 2019/0149510 A1
(43) Pub. Date: May 16, 2019

(54) Method, Addressing Device, Computer Program Product, Industrial System and Facility for Safely Issuing Addresses to Modules in a Network

(71) Applicant: Siemens Aktiengesellschaft, Muenchen (DE)

(72) Inventors: Herbert Barthel, Herzogenaurach (DE); Ulrich TASCHKE, Fuerth (DE); Maximilian WALTER, Nuernberg (DE)

(73) Assignee: Siemens Aktiengesellschaft

(21) Appl. No.: 16/185,479

(22) Filed: Nov. 9, 2018

(30) Foreign Application Priority Data
Nov. 10, 2017 (EP) 17201103.3

(51) Int. Cl. H04L 29/12

(52) U.S. Cl. CPC H04L 61/2046

(57) ABSTRACT

A method and facility for safely issuing addresses to modules connected in a network by a data connection, wherein the address of a respective module comprises a module address and a subsidiary address that specifies the position at which the respective module is located in the network and/or the interface to which the respective module is connected, where as an alternative or additionally the subsidiary address can specify the slot of an interface to which the module is connected, in an addressing step the address is allocated to the respective module and a check is performed via to determine whether the respective address of the respective module is unique, and where if it is not unique, then a signal is provided and, based on the signal, at least for one module the subsidiary address, is changed such that is advantageously possible to issue addresses in a network simple and safely.

### BACKGROUND OF THE INVENTION

### 1. Field of the Invention

The invention relates to a method, an addressing device, a computer program product, an industrial system and a facility for safely issuing addresses to modules in a network.

### 2. Description of the Related Art

As a rule, systems have a plurality of modules, where the modules are connected to a network, in particular by an interface. For example, such modules are switching modules, sensors or also a programmable logic controller. The modules communicate through a network, where the modules are connected to the network. For safe communication the respective module in the network has an address.

EP 3 051 779 A1 discloses a method for safe communication.

### SUMMARY OF THE INVENTION

It is an object of the invention to provide a method and a facility for issuing addresses in a network and, more particularly, to make possible safe communication of the modules in the network.

This and other objects and advantages are achieved in accordance with the invention by a method, a computer program product, an addressing facility, a facility and by an industrial system with such a facility.

The invention is based in particular on the knowledge that a safe communication follows on from a unique addressing of modules in a network. This has been problematic in previous methods for issuing safe addressing. Accordingly, it makes sense to ensure that information from a safety switch is also transferred to the correct controller.

In accordance with the method for safe issuing of addresses to modules in a network, the respective module has a module address or has the module address allocated to it, where the address comprises the module address and a subsidiary address, where the subsidiary address specifies the respective position of the respective module in the network, in an addressing step, the respective module has at least the respective subsidiary address applied to it or the respective address is provided by the respective module, where a check is made in a test step to determine whether the combination of the respective module address with the respective subsidiary address is unique, and where a signal is output in the event of a non-unique allocation of the address.

If necessary the disclosed described method is only undertaken for the addressing of those modules in the network that need safe communication.

Safe communication advantageously occurs between safety-relevant modules, such as emergency stop switch modules, temperature sensor modules, a safety-relevant drive and/or a programmable logic controller. In this way, the method in accordance with the invention can be simplified in a large network with a plurality of modules.

After the respective module has been connected in accordance with the contact plan, the addressing step and/or the test step are advantageously undertaken.

The module can be a processing unit (CPU), such as a programmable logic controller (PLC), an input/output module, a sensor, an actuator, a drive or a switching element.

The network can be configured as Ethernet, in particular as an industrial Ethernet such as PROFI-Bus, PROFI-Net, PROFI-Safe or EtherCAT. The network can also be configured as a non-local network.

A module address can be a Media Access Control (MAC) address. In an especially simple case, the module address can also be the module type, such as a sensor, an actuator, a drive, an I/O module or an I/O interface. The module address advantageously comprises the type and/or the respective function of the respective module. The function of a module is understood, for example, as the measurement of a temperature or the function of an emergency stop switch.

The subsidiary address specifies the point at which the respective module is positioned in the network. In a simple embodiment, the subsidiary address can also specify a slot of the module in a router or in an interface.

To this end, the network can be divided into a plurality of areas or levels. Advantageously, the slot of a module in an interface is a separate level in a network.

The subsidiary address of the respective module also enables each module with the same module address in a network to be addressed uniquely. Thus, safe communication of the modules with one another or communication between the modules is guaranteed.

In the addressing step, a subsidiary address and/or the module address is preferably applied to the module. During the allocation of the module address of the respective module, the function of the respective module is advantageously assigned to the respective module. To do this, the respective module address of the respective module can be interrogated by the network. In a substep, the respective module address can be combined with the respective subsidiary address and provided to the respective module.

As an alternative or in addition, the respective module itself can also provide its module address and/or a subsidiary address.

In the test step, a check can be made to determine whether the respective module has a unique address. Also possible is a check on the uniqueness of the subsidiary address. Through a unique subsidiary address, a module is able to be exchanged in the network, without a new address, in particular a new subsidiary address, having to be issued.

The test step is typically undertaken by making contact with the corresponding module. If contact is successfully made with the corresponding module, then it can be assumed that there is correct addressing and/or a correct position of the module in the network. When contact is made, the module address and/or the function of the respective module are advantageously interrogated. Advantageously, a comparison is made with the contact plan.

When contact is made, a telegram is advantageously supplied to the respective contacted module. The telegram advantageously has the subsidiary address of the contacted module in each case. The contacted module advantageously reacts to the signal by providing its module address and/or its function.

If it is determined that two modules have an identical address or at least an identical subsidiary address for an identical module type of an identical subsidiary address, then a signal is provided.

Advantageously, the module address is allocated to the respective module in the addressing step. During the allocation, the function of the respective module can be checked. If the function of the respective module does not match the expected function, the signal is provided.

A module type is a sensor, a switch, a drive, a programmable logic controller or an input/output module.

The signal can be displayed on a display of a module, which is assigned to the network. The signal can identify the respective modules or one of the modules, which if necessary have/has an identical address or an identical subsidiary address (addresses).

Following the signal, a user can change at least the subsidiary address of one of the modules. Advantageously, the change can also occur in an automated manner, for example, by the structure of the subsidiary address being changed until such time as a unique issuing of the respective address is possible in each case.

It is ensured by the disclosed embodiments of the invention that the issuing of addresses in a network is unique. In this way, safe communication between two modules can be guaranteed.

In an advantageous embodiment of the invention, the method is implemented with an addressing device, where the addressing device is assigned to the network for this purpose.

The addressing device can be formed as hardware or at least in part as a computer program product. The addressing device is advantageously embedded in an engineering platform. An example for an engineering platform is the TIA Portal from Siemens AG. The addressing device can also be implemented as a software application (APP), which is merely executed for the method. The software application is also able to be executed independently.

The effective connection of the addressing device to the network and to the modules can also be made by an effective connection to a process module of the network, such as to a programmable logic controller.

Advantageously, the addressing step and also the test step are undertaken with the aid of the addressing device. Advantageously, the addressing device provides the signal. Advantageously, the module that might possibly have a non-unique address also displays the signal.

The respective changed address is advantageously stored in at least one of the respective process modules and/or is provided by the respective process module.

For an automatic change of the respective address of the respective module, the respective changed address or at least the respective subsidiary address of the respective module can likewise be provided by the addressing device.

After the issuing of the addresses is ended, the addressing device can be removed from the effective area of the network.

The method can be implemented especially safely and simply for the user with the aid of the addressing device.

In a further embodiment of the invention, at least a part of the modules are connected to an interface, where the respective module is connected via the interface to the network.

The interface can be configured as an input/output module. The interface can also be embodied as a network node or as a router. Advantageously the interface connects sensors, actuators or switching elements to the network.

Advantageously, the interface can support the allocation of one of the addresses. Advantageously, the addresses of the module connected to the interface in each case are issued through the interface. If necessary the interface also has an address. As an alternative the interface merely serves to issue the subsidiary address of the module connected to the interface in each case.

Advantageously, an address of the respective module comprises the respective function and the slot of the respective module at the interface. Advantageously, the respective module address comprises the function of the respective module. Also advantageously the subsidiary address comprises the slot of the respective module in the respective interface.

A simple address enables a module to be exchanged without problems for another module with the same function, without the presently described embodiment of the method for issuing an address having to be performed once again.

Advantageously the interface serves to support the communication of the modules that are connected to the interface. To this end, the interface has a connection to the network and also slots for individual modules. The modules that are connected to the interface advantageously communicate through the interface with a further module.

An interface advantageously has a plurality of slots. Slots are connections for modules to the interface. The slots can be embodied by a local bus, e.g., a backplane bus.

Advantageously, the subsidiary address of the respective module corresponds at least partly to the slot of the module occupied in the interface in each case. For example, a first module is connected to a first slot and a second module to a third slot of an interface. Through the different slots, the modules each have a different subsidiary address.

Through the introduction of interfaces for connecting the modules to the network, the respective module does not necessarily need its own address. The interface can, in particular through the slot and the module type, define the address of the module.

Moreover, the interfaces can be constructed identically in each case and coordinate the communication of the respective module with the network.

In a further advantageous embodiment of the invention, the addresses are only provided to the respective module or to the respective interface if the addresses are unique, where after output of the signal and a change of the respective non-unique address, the addressing step is undertaken once again.

Advantageously, the addresses are issued to the respective module with the aid of the addressing device only if the respective address is unique.

The disclosed embodiments of the invention ensure that the combination of the subsidiary addresses behind the interfaces in the network is unique. Thus, via checking of the communication to all (functionally safe) modules concerned it can be shown whether the issuing of addresses is error-free.

Should the signal have been provided, in particular because of a non-uniqueness, at least one of the addresses is changed. The change can be made by switching the slot of the respective module in the interface assigned in each case. The switch can be made automatically or manually.

Thereafter, the test step is advantageously performed. If the test step is successful, then the addresses are assigned to the respective module and/or the respective interface. The assignment can be made with the aid of the addressing device. If the result of the test step is that the assignment of the addresses is unique, then the addressing step is advantageously performed. Here, the addresses can be assigned to the respective module in a permanent or non-volatile manner.

Advantageously, the addressing step can be undertaken in a manner such that the addresses of the respective module are provided and in the subsequent test step the uniqueness of the addresses is checked. The addresses are advantageously provided by the addressing device. The addresses are advantageously also provided to a process module.

In a further advantageous embodiment of the invention the test step is performed after the addressing step, where the respective address is assigned to the respective module if the test step has not determined any non-uniqueness. If it is determined in the test step that two modules have at least one matching subsidiary address, then the respective subsidiary address can be changed.

If it is determined in the test step that the addresses are unique, then the respective address is allocated to the respective module. The address can then be permanently assigned to the module. In particular, the respective address can be stored in a non-volatile manner in the respective module and/or in a process module.

In a further advantageous embodiment of the invention, two modules each communicate with one another by at least one telegram, where the address of the respective telegram is coordinated. The telegram advantageously has the address of the module that provides the telegram.

If the respective module is connected to an interface, then the telegram can also be provided to the network by the interface.

Depending on the specific embodiment, only the address of the module or interface from which the telegram emanates is assigned to the telegram. In a uniquely directed communication, the address of that module which is to be the recipient of the telegram can also be assigned to the telegram. Thus, an emergency stop switch module can communicate exclusively with a programmable logic controller or a further module, which transfers the system into a safe state upon receipt of a telegram from the emergency stop switch module. The assignment of the respective address to a telegram allows a safe and targeted communication of modules in the network.

In a further embodiment of the invention, the subsidiary address is determined by the connection to the respective interface. By determining the address of the respective module connected to the module, the subsidiary address can be defined by the slot.

Advantageously, in a simple embodiment of the invention, the address of the respective module comprises the slot, at which the respective module is connected to the interface, and the module type, e.g., switching module, a sensor module or an actuator (module).

The assignment of the slot to an interface enables the address to be assigned easily and especially safely. The possibility of an unrecognized telegram being provided by an incorrect sensor can thus be excluded with a high degree of certainty.

In a further advantageous embodiment of the invention, the respective address is stored at least in the respective module, in the respective interface and/or in the addressing device. The respective address is advantageously stored when no signal is provided.

Advantageously, the address is stored in the respective interface to which the respective module is connected. Advantageously the respective address is stored in the respective module in a non-volatile manner. As an alternative or in addition, the addresses are stored in the addressing device and/or a process module, in particular in a non-volatile manner.

The respective address is preferably stored in the respective process module, e.g., the programmable logic controller, and optionally in the respective module or in the respective interface that is assigned to the respective module.

The storage of the respective address of the module in the respective interface enables the module to be exchanged without a new address having to be assigned. The address can also be stored in the respective module itself. Thus, even if the process module fails, the communication can continue to be maintained between the further modules.

In a further advantageous embodiment of the invention, the respective module is a sensor, an actuator, a switching element, or a programmable logic controller.

An actuator is in particular a drive, e.g., a motor, which is connected to the network via a frequency converter.

A switching element or a switch module can be an emergency stop switch, a light barrier or a selector switch for a function mode of a system.

The programmable logic controller often serves as a process module, for example, for open-loop or closed-loop control of modules, in particular of the respective actuators. The programmable logic controller advantageously serves to support the method described here and/or to support the addressing device.

In a further advantageous embodiment of the invention, a contact plan is created, where the positioning of the respective module in the network or a connection of the respective module to the respective slot of the respective interface is undertaken with reference to the contact plan.

The creation of a contact plan is further advantageously undertaken, where the positioning of the respective module, in particular of all modules, in the network is undertaken, and/or the respective connection of the respective module, preferably of all modules to their respective slot of the respective interface is undertaken with reference to the contact plan, where a check is made to determine whether the respective module or preferably all modules are able to be reached in accordance with the contact plan.

With a positive result, in particular when the respective module is able to be reached in accordance with the contact plan, a positive test signal is output. The positive test signal shows that the respective module is able to be reached, or that all modules are able to be reached in accordance with the contact plan. With a positive test signal, the user is advantageously notified that the respective connection in the network is functioning in an error-free manner or is safe.

Advantageously, the contact plan is created with the aid of a computer program product, in particular an engineering tool.

The respective module is positioned by the connection of the module to the corresponding point of the network. In particular, the module is positioned through the connection of the respective module to the respective slot of the respective interface.

After the connection of the respective module to the network and/or the respective interface, the allocation of the respective module address and/or of the respective subsidiary address is undertaken. Advantageously, after allocation of the address, a check is performed with the aid of the test step to determine whether the respective module has been connected at the correct point. This check only shows a positive result when all functionally safe modules give a positive acknowledgement via the contact plan of the computer program product. In the event of a positive result, this is advantageously displayed. Here, this embodiment produces an especially simple and safe issuing of addresses.

The computer program product is embodied to be installed and executed on a processing unit, where the computer program product serves to implement the described embodiments of the method in accordance with the invention. The computer program product advantageously comprises the addressing device. The computer program product is advantageously at least a part of an engineering tool. The computer program product can be an application or a software function of the engineering tool. An example of an engineering tool is the TIA portal from Siemens AG.

The processing unit is assigned at least for a time to the network or is connected to the network. The computer program product is advantageously connected by a process module, in particular by a programmable logic controller. A programmable logic controller suitable for this purpose is a SIMATIC PLC from Siemens AG.

By performing the described embodiments of the method with the aid of the computer program product, the addresses can be issued to the respective module in a simple and automated manner.

In an advantageous embodiment of the invention the addressing device is formed as a part of the engineering tool. Advantageously, the addressing device is formed as a software application of the engineering tool.

The integration of the addressing device into an existing engineering tool enables the method to be performed especially simply.

The computer program product is advantageously configured to create the contact plan, where the contact plan in particular specifies the respective slot for the respective module at the respective interface.

The facility has a plurality of modules, where the modules are each connected to one another through a network, where the respective module has an address in each case, where the address comprises a module address and a subsidiary address, where the modules are configured for safe communication, and where the subsidiary address of the respective module is defined by the position in the network.

The facility advantageously features the modules and the network. The facility can be configured to implement a described embodiment of the method here. The facility can be configured in particular as a drive system. The modules can be individual drives, which are each connected to the network via a frequency converter.

The unique addressing makes an especially safe communication possible. Thus, the facility and possibly a system that features the facility can obtain a high safety certification, such as SIL 2 or SIL 3.

In an advantageous embodiment of the invention, at least a part of the modules are (effectively) connected via an interface to the network, where each respective interface has a plurality of slots, and where the subsidiary address of the module corresponds to the slot.

The respective interface is advantageously constructed in the same way. The at least one part of the subsidiary address of the module connected in each case to the interface is connected in each case to the slot of the respective module at the interface.

An interface advantageously has a plurality of slots for a module in each case. The module can be assigned a subsidiary address based on the respective slot. The allocation and/or the changing of the slot of the respective module can be undertaken manually by a user. This embodiment of the invention makes the addressing of modules in such a network especially simple and safe.

In a further advantageous embodiment of the invention, a module address features a module type. A module type specifies the layout or the function of the respective module. For example, a module type is a sensor type, an actuator type, a programmable logic controller type or an input/output module type. Optionally, an interface can also be a module with the module type interface.

Advantageously, the module type and/or the respective MAC address of the respective module form the module address.

The industrial system preferably has at least one of the above-described facilities. The industrial system is preferably configured as a production machine, as a machine tool, or to produce a basic material.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described and explained in greater detail below with reference to figures. The features shown in the figures can be combined into new forms of embodiment without departing from the scope of the invention, in which:

FIG. 1 shows a network in accordance with the invention;

FIG. 2 shows a further network in accordance with the invention;

FIG. 3 shows a method scheme in accordance with the invention; and

FIG. 4 is a flowchart of the method in accordance with the invention.

### DETAILED DESCRIPTION OF THE EXEMPLARY EMBODIMENTS

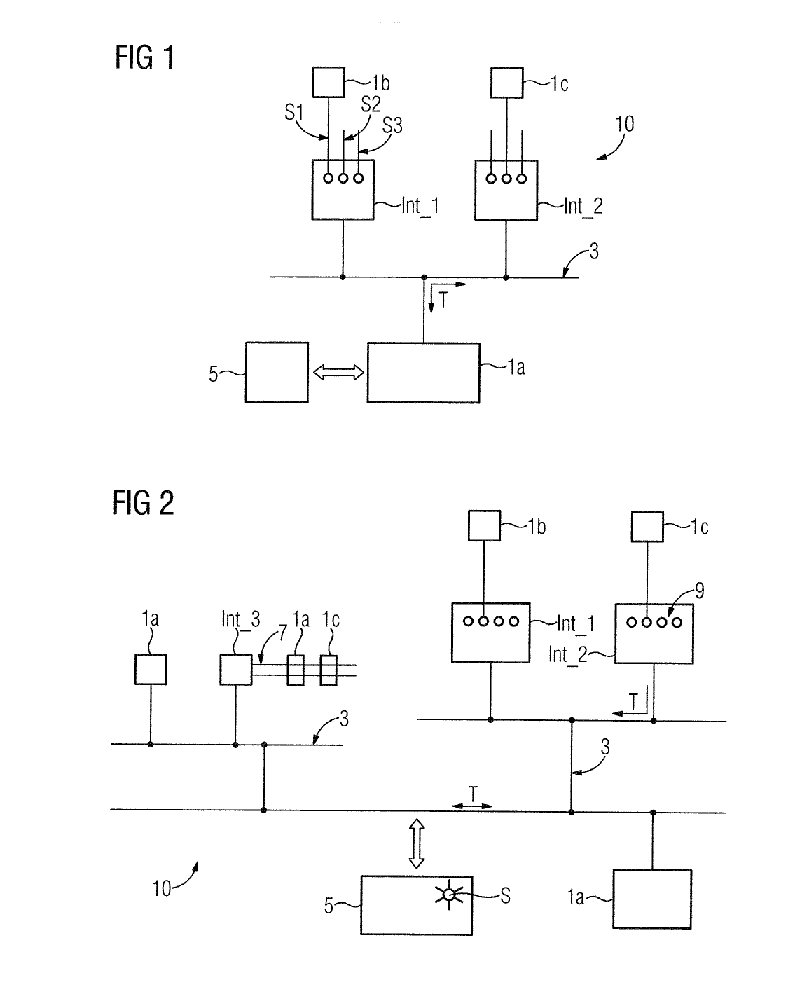

FIG. 1 shows a network 10. The network 10 has a first module 1a. The first module 1a is preferably configured as a process module, such as a programmable logic controller. The first module 1a is coupled to an addressing facility 5. The first module 1a is coupled via a data connection 3 to a first interface Int_1 and to a second interface Int_2 in each case.

The respective interface Int_1, Int_2 has slots S1, S2, S3 in each case. The slots S1, S2, S3 each serve to connect a module 1b, 1c. In the interface Int_1, a second module 1b is connected to a first slot S1 and is thus connected to the first interface Int_1. The second interface Int_2 likewise has three slots S1, S2, S3 for connection of modules 1a, 1b, 1c.

A third module 1c is connected to the second interface Int_2. The connection of the third module 1c is made to the second slot S2 in each case. Thus, the address A of the respective modules 1a, 1b, 1c is different, because the subsidiary addresses Int(1a), Int(1b), Int(1c) are each different.

The respective slot S1, S2, S3, together with the module type, forms a module address A(1a), A(1b), A(1c). Through the use of different slots for the module 1b, 1c connected to the interface Int_1, Int_2 in each case, even with otherwise identical module addresses or module types, an address A that can be differentiated is produced. The communication of the modules T is undertaken via telegrams T, where the telegram T is provided in each case by the data connection 3 to the modules 1a, 1b, 1c.

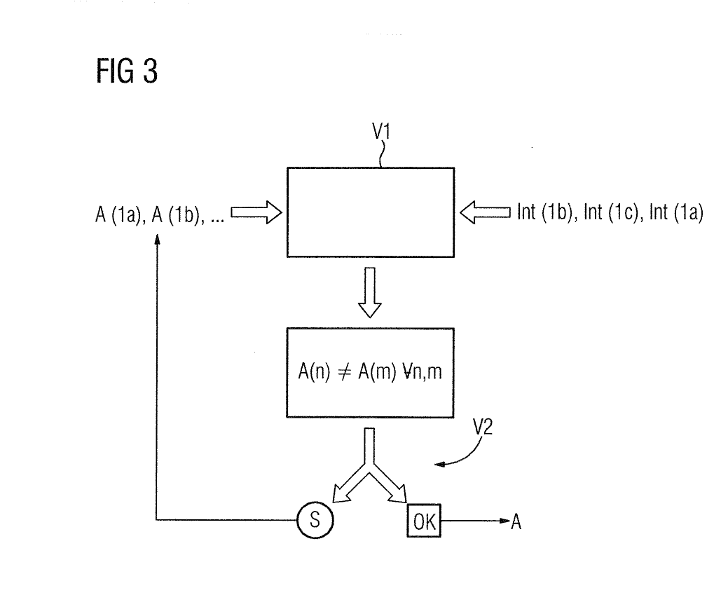

FIG. 2 shows a further network 10 in accordance with the invention. The further network has a first module 1a, where the first module is connected directly to the data connection 3. Further modules 1b, 1c are each connected via an interface Int_1, Int_2, Int_3 in to the data connection 3. The further modules 1b, 1c each communicate via the data connection 3 via the interface Int_1, Int_2, Int_3 connected to them.

The respective interface Int_1, Int_2, Int_3 has a plurality of slots S1, S2, S3 in each case, where the slots S1, S2, S3 can also be embodied as connections to a backplane bus system 7.

The network has a number of levels. The levels can each define a subsidiary portion of the address A of the respective module 1a, 1b, 1c.

One of the characterizing features of the network 10 shown is that a first module 1a can be connected via an interface Int_3 and also directly to the data connection 3. The first module 1a can be configured as a process module.

The second module 1b and the third module 1c are a switch for example, i.e., configured as the same module type. The same slot in each respective interface Int_1, Int_2 accordingly produces a matching address A, if necessary.

An addressing facility 5 serves to issue the addresses to the respective module 1a, 1b, 1c. The addressing facility 5 is coupled to the network 10. To this end, the addressing facility can be connected directly to the data connection 3.

The possibly matching address of the second module in each case at the first interface Int_1 and of the third module 1c at the second interface Int_2 allows the addressing facility 5 to provide a signal S.

By a manual re-plug of the second module at the first interface to the third slot S3, the uniqueness of the address can be established.

Preferably, the addressing device has a display, upon which an advantageous option for re-plugging is shown to the user.

The modules 1a, 1b, 1c advantageously communicate via telegrams T, which are transmitted by the data connection 3 from the module 1a, 1b, 1c providing them to the receiving module 1a, 1b, 1c.

FIG. 3 shows a method scheme in accordance with the invention. The method scheme has an addressing step v1 and a test step v2 auf. In the addressing step, the respective subsidiary address Int(1a), Int(1b) is assigned to the respective module addresses A(1a), A(1b), A(1c). The subsidiary address, in the version shown here, has the slot S1, S2, S3 of the respective module 1a, 1b, 1c at the respective interface Int_1, Int_2, Int_3. The respective addresses A(n) are provided from the respective module address A(1a), A(1b), A(1c) and the respective subsidiary address Int(1a), Int(1b), Int(1c).

In the test step, a check is performed to determine whether the respective addresses, at least in its module address A(1a), A(1b), A(1c) and the associated subsidiary address Int(1a), Int(1b), Int(1c), are uniquely issued. Thus, a check is performed to determine whether the addresses are each different (A(n)≠A(m)) for all n, m (n, m=1a, 1b, 1c, . . . ).

If the addresses A are each different, then the addresses A are assigned to the respective module 1a, 1b, 1c. Preferably, the addresses A are stored.

If two addresses are possibly the same, then a signal S is output. Based on the signal S, the module addresses are changed in part to new addresses in relation to the respective subsidiary addresses Int(1a), Int(1b), Int(1c). The test step v2 is then performed again.

If the result of the test step (v2) is that the assignment of the addresses (A) is unique, then the addressing step (v1) is performed. Here, the addresses (A) are assigned to the respective module. These addresses are preferably permanently held in the network or are stored in a memory, in particular the memory of a process module.

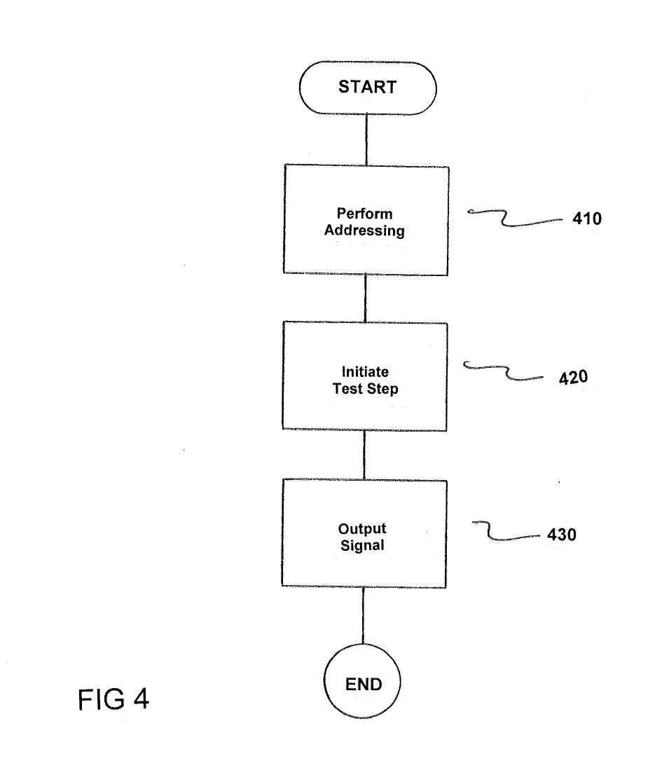

FIG. 4 is a flowchart of a method for safely issuing addresses to modules 1a, 1b, 1c in a network 10, respective modules 1a, 1b, 1c including a module address A(1a), A(1b), A(1c), where respective addresses A each comprise the module address A(1a), A(1b), A(1c) and a subsidiary address Int(1a), Int(1b), Int(1c) that specifies a respective position of a respective module 1a, 1b, 1c in the network 10.

The method comprises performing an addressing step v1 to either apply a respective subsidiary address Int(1a), Int(1b), Int(1c) to the respective module (1a, 1b, 1c) or provide the respective address A by the respective module 1a, 1b, 1c, as indicated in step 410. Next, a test step v2 is initiated to check whether a combination of the respective module address A(1a), A(1b), A(1c) with the respective subsidiary address Int(1a), Int(1b), Int(1c) is unique, as indicated in step 420. Next, a signal S is output for a non-unique assignment of the addresses A, as indicated in step 430.

In summary, the disclosed embodiments of the invention relate to a method and a facility for safely issuing addresses A to modules 1a, 1b, 1c, which are connected in a network 10 by a data connection 3. The address A of the respective module 1a, 1b, 1c comprises a module address A(1a), A(1b), A(1c) and a subsidiary address Int(1a), Int(1b), Int(1c). The subsidiary address Int(1a), Int(1b), Int(1c) specified the position at which the respective module 1a, 1b, 1c is located in the network 10 and/or the interface Int_1, Int_2, Int_3 at which the respective module 1a, 1b, 1c is connected. As an alternative or in addition, the subsidiary address Int(1a), Int(1b), Int(1c) can specify the slot S1, S2, S3 of the respective interfaces Int_1, Int_2, Int_3 to which the module 1a, 1b, 1c is connected. In an addressing step v1, the address A is allocated to the respective module 1a, 1b, 1c and in a test step v2, a check is performed to determine whether the respective address A of the respective module 1a, 1b, 1c is unique. If it is not unique, then a signal S is provided. Based on the signal S, the subsidiary address Int(1a), Int(1b), Int(1c) is changed, at least for one module 1a, 1b, 1c. Advantageously, it is possible to issue addresses A in a network 10 in this way in a simple and safe manner.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for safely issuing addresses to modules in a network, respective modules including a module address, respective addresses each comprising the module address and a subsidiary address which specifies a respective position of a respective module in the network, the method comprising:
performing an addressing step to one of (i) apply a respective subsidiary address to the respective module and (ii) provide the respective address by the respective module;
initiating a test step to check whether a combination of the respective module address with the respective subsidiary address is unique; and
outputting a signal for a non-unique assignment of the addresses.

2. The method as claimed in claim 1, wherein the method is performed with an addressing device which assigned to the network to implement the method.

3. The method as claimed in claim 1, wherein at least a part of the modules is connected to an interface; and wherein the respective module is connected via the interface to the network.

4. The method as claimed in claim 3, wherein the subsidiary address is defined by the connection to a respective interface.

5. The method as claimed in claim 4, wherein the addresses are only provided to one of (i) the respective module and (ii) the respective interface if the addresses are unique; and wherein the addressing step is performed again for a respective non-unique address after output of the signal.

6. The method as claimed in claim 1, wherein a plurality of modules each communicate with one another via at least one telegram; and wherein a respective address is associated with the telegram.

7. The method as claimed in claim 6, wherein the respective address is stored in at least one of (i) the respective module, (ii) a respective interface and (iii) an addressing device.

8. The method as claimed in claim 1, wherein the respective module comprises one of (i) a sensor, (ii) an actuator, (iii) a switching element and (iii) a programmable logic controller.

9. The method as claimed in claim 1, further comprising:
creating a contact plan;
wherein at least one of (i) a positioning of the respective module within the network is performed based on the contact plan and (ii) the respective connection of the respective module to its respective slot of the respective interface is performed based on the contact plan;
wherein a check is performed to determine whether the respective module reachable in accordance with the contact plan.

10. The method as claimed in claim 9, wherein at least one of (i) said position, (ii) said respective connection and (iii) said check is performed for all modules.

11. A non-transitory computer program product for installation and execution on a processing unit, the computer program product including computer program code which, when executed by the processing unit causes safe issuance of addresses to modules in a network the computer program code comprising:
program code for performing an addressing step to one of (i) apply a respective subsidiary address to a respective module and (ii) provide a respective address by the respective module;
program code for initiating a test step to check whether a combination of a respective module address with the respective subsidiary address is unique; and
program code for outputting a signal for a non-unique assignment of the addresses.

12. The non-transitory computer program product as claimed in claim 11, wherein an addressing facility is formed as part of an engineering tool.

13. An addressing device, comprising:
a display;
wherein the addressing device is assigned to at least one of (i) a module and (ii) a network for a period of time; and
wherein the addressing device is configured to:
perform an addressing step to one of (i) apply a respective subsidiary address to a respective module and (ii) provide a respective address by the respective module;
initiate a test step to check whether a combination of a respective module address with the respective subsidiary address is unique; and
output a signal for a non-unique assignment of the addresses.

14. A facility comprising:
a plurality of modules each interconnected to one another by a network;
wherein each respective module of the plurality of modules includes an address which comprises a module address and a subsidiary address;
wherein each of the plurality of modules are configured for safe communication;
wherein the subsidiary address of the respective module is defined by a position of the respective module in the network;
wherein a respective address is issued by:
performing an addressing step to one of (i) apply a respective subsidiary address to a respective module and (ii) provide a respective address by the respective module;
initiating a test step to check whether a combination of a respective module address with the respective subsidiary address is unique; and
outputting a signal for a non-unique assignment of the addresses.

15. The facility as claimed in claim 13, wherein at least one part of the plurality of modules is effectively connected via an interface to the network; wherein each respective interface has a plurality of slots; and wherein the subsidiary address of the respective module corresponds to the slot.

16. The facility as claimed in claim 14, wherein the module address features one of (i) a module type and (ii) a function.

17. The facility as claimed in claim 15, wherein the module address features one of (i) a module type and (ii) a function.

18. An industrial system having the facility as claimed in claim 14.
